(19) United States
(12) Patent Application Publication
(10) Pub. No.: US 2020/0149736 A1
(43) Pub. Date: May 14, 2020

(54) RETRACTABLE WATER CANNON APPARATUS

(71) Applicant: Clyde Bergemann, Inc., Atlanta, GA (US)

(72) Inventors: Trevor Russell, Atlanta, GA (US); Tony Watkins, Atlanta, GA (US); Bruce Townsend, Atlanta, GA (US); John Edenfield, Atlanta, GA (US); Samir Patil, Atlanta, GA (US); Danny Tandra, Atlanta, GA (US)

(21) Appl. No.: 16/680,492

(22) Filed: Nov. 11, 2019

Related U.S. Application Data
(60) Provisional application No. 62/758,460, filed on Nov. 9, 2018.

(51) Int. Cl. F22B 37/54; B08B 3/02; F28G 1/16; B05B 1/26

(52) U.S. Cl. CPC F22B 37/545; B05B 1/26; F28G 1/163; B08B 3/024

(57) ABSTRACT

A system for cleaning an interior of a boiler may include a lance tube operatively coupled to one or more positioning devices, and a cleaning tip coupled to one or more insertion devices. The lance tube may include a distal end from which pressurized water flows out of the lance tube into the interior of the boiler. The one or more positioning devices may be configured for moving the distal end of the lance tube in an X direction and/or a Y direction relative to a wall of the boiler to direct the flow of water from the distal end of the lance tube. The one or more insertion devices may be configured for moving the cleaning tip between a retracted position and an extended position.

### CROSS-REFERENCE TO RELATED APPLICATION

This application claims the benefit of, and priority to, U.S. Provisional Patent Application No. 62/758,460, filed on Nov. 9, 2018, and titled “Retractable Water Cannon Apparatus,” the disclosure of which is expressly incorporated herein by reference in its entirety.

### FIELD OF THE DISCLOSURE

The present disclosure relates generally to systems for cleaning interior surfaces of a boiler and more particularly to systems and devices for clearing deposits obstructing a port opening of a boiler prior to cleaning interior surfaces of the boiler.

### BACKGROUND OF THE DISCLOSURE

The entrainment of fly ash particles, due to combustion in the lower furnace of an industrial boiler, to the furnace walls and convection sections of the boiler is an inevitable process. The accumulation of these particles/deposits on the fireside heat exchanger surfaces reduces the boiler thermal efficiency. Water jets often are used to remove the slag deposits from the furnace wall. Cleaning devices used to form and direct the water jet (usually known as a water cannon or hydrojet) generally have opening access to the boiler wall through a port opening specifically designed for such devices. In some instances, deposits can form to a degree as to partially or fully obstruct the port opening in the boiler wall. Such blockage can hinder the water jet flow and reduce the cleaning efficiency of the jet. Partial or full blockages typically are removed by manually clearing them using a rod to punch though the deposit. Such manual removal generally requires disassembling the cleaning device components to allow an operator to gain access to the blockage. As a result, the operator is exposed to extreme temperatures, flue gases, and dangerous conditions during manual removal of deposits.

Thus, a device is needed for clearing blockages obstructing a port opening of an industrial boiler without the need for physical human interaction and exposure to extreme temperature and flue gas and for withstanding the extreme conditions of the industrial boiler.

### SUMMARY OF THE DISCLOSURE

The present disclosure provides cleaning systems for cleaning an interior of a boiler and related methods of using such cleaning systems. In one implementation, a cleaning system for cleaning an interior of a boiler may include a lance tube operatively coupled to one or more positioning devices, and a cleaning tip coupled to one or more insertion devices. The lance tube may include a distal end from which pressurized water flows out of the lance tube into the interior of the boiler. The one or more positioning devices may be configured for moving the distal end of the lance tube in an X direction and/or a Y direction relative to a wall of the boiler to direct the flow of water from the distal end of the lance tube. The one or more insertion devices may be configured for moving the cleaning tip between a retracted position and an extended position.

In some implementations, the cleaning tip is coupled to the lance tube. In some implementations, the cleaning tip includes a fixed portion that is coupled to the lance tube and a movable portion that slides axially relative to the fixed portion in a direction of a port opening defined by the wall of the boiler. In some implementations, the fixed portion and the movable portion are co-axial with the lance tube. In some implementations, the one or more positioning devices include one or more positioning actuators, and the one or more insertion devices include one or more insertion actuators. In some implementations, the cleaning system further includes a control system including a processor in communication with a memory, with the processor executing computer-readable instructions stored at the memory, and with the computer-readable instructions causing the processor to generate and communicate at least one positioning signal to the one or more positioning actuators to cause the one or more positioning actuators to move the lance tube in the X direction and/or the Y direction and to generate and communicate at least one insertion signal to the one or more insertion actuators to cause the one or more insertion actuators to move the cleaning tip between the retracted and the extended positions.

In some implementations, the one or more positioning devices include an X-positioning device and a Y-positioning device. In some implementations, the one or more insertion devices include a pneumatic cylinder. In some implementations, the distal end of the lance tube includes a nozzle, and the nozzle is insertable into the interior of the boiler. In some implementations, the lance tube includes an inner lance tube portion and an outer lance tube portion that are co-axial with one another, and the inner lance tube portion is axially slidable relative to the exterior lance tube portion. In some implementations, the inner lance tube portion is coupled to the one or more insertion devices, and the one or more insertion devices are configured for causing a distal end of the inner lance tube portion to extend into and retract from the interior of the boiler. In some implementations, the outer lance tube portion is fixedly coupled to an articulating joint that rotates about a central point but does not translate in the X direction or the Y direction. In some implementations, the one or more positioning devices include an X-positioning device and a Y-positioning device. In some implementations, the outer lance tube portion is coupled to the X-positioning device and the Y-positioning device. In some implementations, the one or more insertion devices include a pneumatic cylinder.

These and other aspects and improvements of the present disclosure will become apparent to one of ordinary skill in the art upon review of the following detailed description when taken in conjunction with the several drawings and the appended claims.

### BRIEF DESCRIPTION OF THE DRAWINGS

FIG. 1A is a schematic diagram of a cleaning system for cleaning an interior of a boiler in accordance with one or more implementations of the disclosure, showing a water jet directed from a lance tube of the cleaning system to remove deposits formed on a boiler wall of the boiler.

FIG. 1B is a schematic diagram of the cleaning system of FIG. 1A, showing deposits obstructing a port opening of the boiler.

FIG. 2A is a schematic diagram of a cleaning system for cleaning an interior of a boiler in accordance with one or more implementations of the disclosure, showing deposits obstructing a port opening of the boiler and a cleaning tip of the cleaning system in a retracted portion.

FIG. 2B is a schematic diagram of the cleaning system of FIG. 2A, showing the cleaning tip in an extended position for clearing the deposits obstructing the port opening.

FIG. 2C is a schematic diagram of the cleaning system of FIG. 2A, showing the cleaning tip in the retracted position after clearing the deposits obstructing the port opening.

FIG. 2D is a schematic diagram of the cleaning system of FIG. 2A, showing a water jet directed from a lance tube of the cleaning system to remove deposits formed on a boiler wall of the boiler.

FIG. 3 is a perspective view of a cleaning system for cleaning an interior of a boiler in accordance with one or more implementations of the disclosure.

FIG. 4 is a schematic diagram of a computer as may be used for implementing a control system of a cleaning system for cleaning an interior of a boiler in accordance with one or more implementations of the disclosure.

The detailed description is set forth with reference to the accompanying drawings. The drawings are provided for purposes of illustration only and merely depict example implementations of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various implementations may utilize elements or components other than those illustrated in the drawings, and some elements and/or components may not be present in various implementations. The use of singular terminology to describe a component or element may, depending on the context, encompass a plural number of such components or elements and vice versa.

### DETAILED DESCRIPTION OF THE DISCLOSURE

In the following description, specific details are set forth describing some implementations consistent with the present disclosure. Numerous specific details are set forth in order to provide a thorough understanding of the implementations. It will be apparent, however, to one skilled in the art that some implementations may be practiced without some or all of these specific details. The specific implementations disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one implementation may be incorporated into other implementations unless specifically described otherwise or if the one or more features would make an implementation non-functional. In some instances, well known methods, procedures, components, and circuits have not been described in detail so as not to unnecessarily obscure aspects of the implementations.

Various implementations relate generally to cleaning a furnace wall and/or a convection section of an industrial boiler using a jet of water sprayed onto deposits and more particularly to a device with a means of directing the jet of water for cleaning heat exchangers of an industrial boiler and a control system which provides power and signals to the device and related components. For example, various implementations of a system for cleaning interior surfaces of a boiler include at least one lance tube or other similar device and one or more positioning devices to move a distal end of the lance tube in an X direction and/or a Y direction relative to a wall of the boiler for directing a water (or other fluid) jet stream from the distal end.

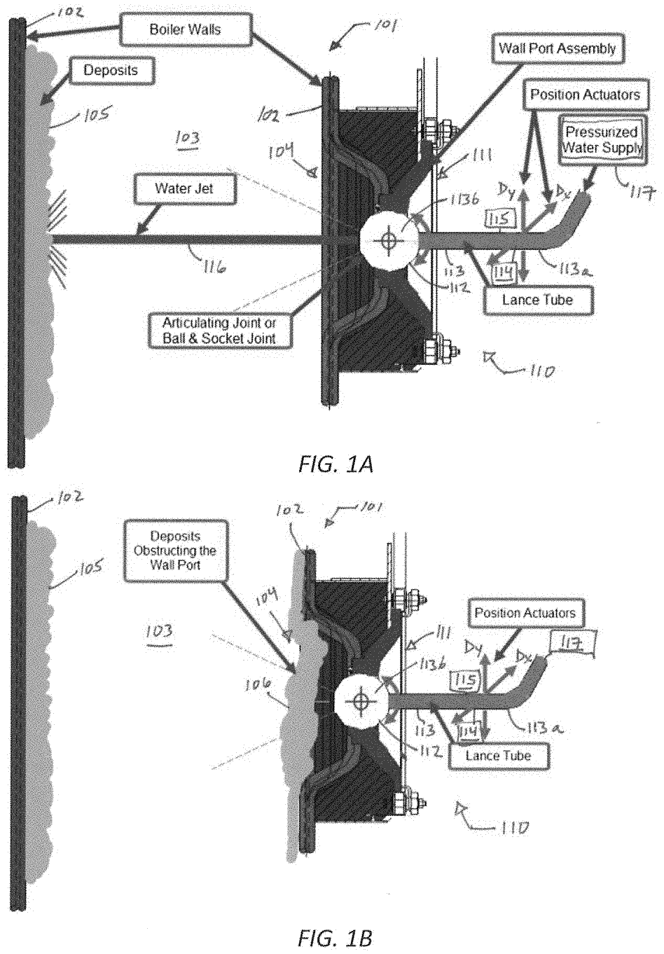

FIGS. 1A and 1B illustrate an implementation of a cleaning system 110 for cleaning interior surfaces of a boiler 101. The boiler 101 includes one or more boiler walls 102 defining an interior 103 of the boiler 101. As shown, the cleaning system 110 includes a wall port assembly 111 coupled to an exterior surface of a boiler wall 102 adjacent to a port opening 104 defined in the boiler wall 102. The wall port assembly 111 includes an articulating joint 112 (e.g., a ball and socket joint) that is rotatable within the wall port assembly 111 but is not translatable in the X direction Dx or the Y direction DY within the wall port assembly 111. The wall port assembly 111 also includes a lance tube 113 that extends through and/or is coupled to the articulating joint 112. As shown, the lance tube 113 includes an exterior portion 113a and an interior portion 113b. The wall port assembly 111 further includes one or more positioning devices that are operably coupled to the lance tube 113 to facilitate movement of the lance tube 113. As shown, the wall port assembly 111 includes an X-positioning device 114 and a Y-positioning device 115 each coupled to the exterior portion 113a of the lance tube 113. The exterior portion 113a of the lance tube 113 extends from the articulating joint 112 and is external to the boiler wall 102. Movement of the exterior portion 113a of the lance tube 113 by the X-positioning device 114 and the Y-positioning device 115 moves the interior portion 113b of the lance tube 113 via rotation of the articulating joint 112. The interior portion 113b of the lance tube 113 can be disposed within the articulating joint 112, internal to the wall port assembly 111, and/or internal to the port opening 104 in the boiler wall 102. The distal end of the lance tube 113 is defined by the interior portion 113b thereof. The wall port assembly 111 allows the lance tube 113 access into the interior 103 of the boiler 101 but prevents the heat, steam, or other elements from the interior 103 of the boiler 101 from escaping to the surrounding environment.

Various implementations of the positioning devices 114, 115 include positioning actuators (e.g., motor-driven linear actuators and/or pneumatic cylinders) and/or other suitable types of mechanical positioning devices. The positioning devices 114, 115 are disposed outside of the boiler 101 and in near proximity to the wall port assembly 111. In some implementations, the positioning devices 114, 115 are coupled to the wall port assembly 111.

To clean the interior surfaces of the boiler 101, the distal end of the lance tube 113 is directed toward the surface of the boiler wall 102 to be cleaned using the X-positioning device 114 and the Y-positioning device 115, and a jet 116 of pressurized water or other fluid, provided to the lance tube 113 by a fluid supply 117, flows through the distal end of the lance tube 113. For example, the distal end of the lance tube 113 may be directed toward the surface of the boiler wall 102 by aligning a central axis of the lance tube 113 to intersect the surface to be cleaned. As shown in FIG. 1A, the distal end of the lance tube 113 may be directed toward the surface of a portion of the boiler wall 102 disposed opposite the port opening 104 for removing deposits 105 formed thereon. The distal end of the lance tube 113 may include a nozzle for controlling one or more characteristics of the fluid flow through the distal end of the lance tube 113.

To spray the water jet 116 to clean the interior surfaces of the boiler 101 using the cleaning system 110, the port opening 104 must be unobstructed. However, deposits 106 can build up over all or a portion of the port opening 104, as shown in FIG. 1B. To clear these deposits 106, various implementations of cleaning systems described herein further include a cleaning tip that clears the partially or fully obstructed port opening before the cleaning cycle begins, and one or more insertion devices for moving the cleaning tip between an extended position and a retracted position. In the retracted position, the cleaning tip is disposed outside of the interior 103 of the boiler 101 and out of contact with the deposits 106 obstructing the port opening 104. In the extended position, the cleaning tip is moved toward at least a portion of the deposits 106 obstructing the port opening 104 and into contact with at least a portion of the deposits 106 to push the deposits 106 away from the port opening 104 and into the interior 103 of the boiler 101. The cleaning systems also may include a control system, as described below, for providing power and signals to the positioning devices and the insertion devices.

Various implementations of insertion devices include insertion actuators (e.g., motor-driven linear actuators and/or pneumatic cylinders) and/or other suitable types of mechanical insertion devices.

In operation, the cleaning tip is directed toward the deposits 106 to be cleared while in the retracted position. For example, the cleaning tip may be moved such that a central axis of the cleaning tip aligns with (intersects) the deposits 106 to be cleared. Then, the insertion device is triggered to cause the cleaning tip to move to the extended position, which causes the cleaning tip to contact the deposits 106 and push them into the interior 103 of the boiler 101. The insertion device is then triggered to cause the cleaning tip to move back to the retracted position. The process can be repeated to clear additional deposits 106 over the port opening 104 until the port opening 104 is clear. Each unique position in which the cleaning tip is extended is cleared of obstructing deposits 106. Repeated extensions at different positions serve to clear the entire wall port assembly 111 of obstructing deposits 106.

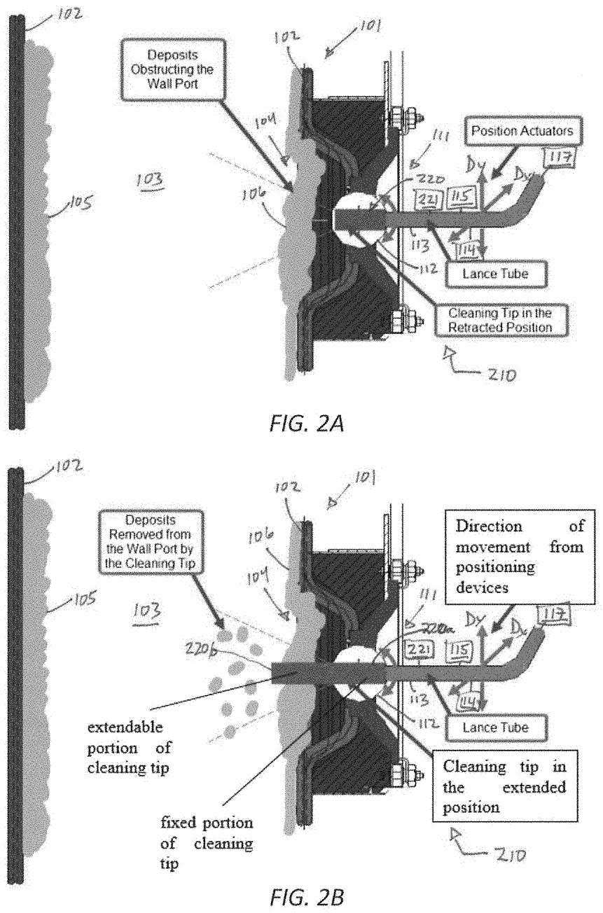

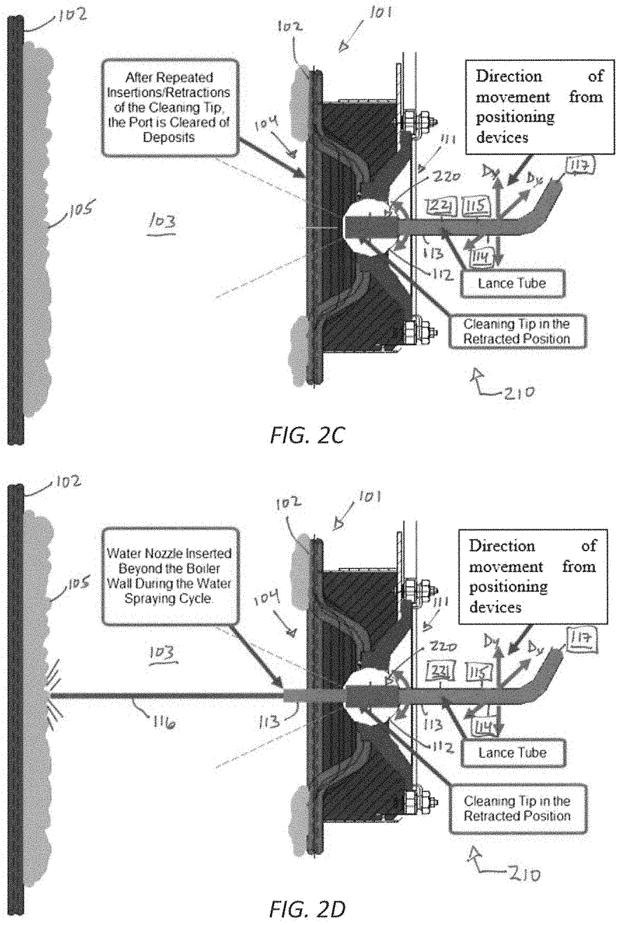

FIGS. 2A-2D illustrate an implementation of a cleaning system 210 for cleaning interior surfaces of the boiler 101. Similar to the cleaning system 110 described above, the cleaning system 210 includes the wall port assembly 111 having the articulating joint 112, the lance tube 113, the X-positioning device 114, and the Y-positioning device 115. The cleaning system 210 also includes a cleaning tip 220 coupled to one or more insertion devices 221 configured for moving the cleaning tip 220 between a retracted position and an extended position. As shown in FIG. 2A, deposits 106 may extend over the port opening 104 in the boiler wall 102 prior to beginning a cleaning cycle with the cleaning system 210. As shown in FIG. 2B, prior to directing the water jet 116 through the port opening 104, the deposits 106 are cleared from the port opening 104 by moving the cleaning tip 220 such that the central axis of the cleaning tip 220 aligns with at least a portion of the deposits 106, extending the cleaning tip 220 through the port opening 104 to push the deposits 106 away from the port opening 104 and into the interior 103 of the boiler 101, and then retracting the cleaning tip 220. FIG. 2C shows the cleaning tip 220 in the retracted position after the deposits 106 have been cleared from the port opening 104. FIG. 2D shows the distal end of the lance tube 113 extended through the port opening 104 beyond the boiler wall 102 to direct the water jet 116 toward another portion of the boiler wall 102.

According to the illustrated implementation, the cleaning tip 220 is a telescoping device that includes a fixed portion 220a and at least one extendable portion 220b. The fixed portion 220a is fixedly coupled around an outer perimeter of the lance tube 113 such that the fixed portion 220a and the lance tube 113 are co-axial. The at least one extendable portion 220b also is co-axial with the fixed portion 220a and the lance tube 113 and is axially slidable relative to the fixed portion 220a and the lance tube 113. At least the extendable portion 220b is separately formed from the lance tube 113, and the fixed portion 220a also may be separately formed from the lance tube 113. The insertion device 221 has a moveable portion that is coupled to the extendable portion 220b of the cleaning tip 220. To extend the cleaning tip 220 through the port opening 104 to push away the deposits 106 extending over the port opening 104, the one or more insertion devices 221 are triggered to slide the extendable portion 220b of the cleaning tip 220 axially relative to the lance tube 113 such that the distal end of the cleaning tip 220 engages and pushes away the deposits 106. Once the deposits 106 are cleared, the cleaning tip 220 is retracted, as shown in FIG. 2C. Then, as shown in FIG. 2D, the distal end of the lance tube 113 is extended through the port opening 104 to direct the jet 116 of pressurized water or other fluid toward the surface of the boiler wall 102 for removing the deposits 105 therefrom. The distal end of the lance tube 113 may be extended and retracted by one or more insertion devices. When the cleaning cycle is completed, the distal end of the lance tube 113 is retracted such that it is disposed external to the boiler 101. However, in other implementations, the distal end of the lance tube 113 is not retracted or extended. In such implementations, a distance between the distal end of the lance tube 113 and the articulating joint 112 remains constant. Also, in other implementations, the cleaning tip 220 may not be disposed co-axial with the lance tube 113. For example, the cleaning tip 220 may be coupled to the lance tube 113, but the cleaning tip 220 and the lance tube 113 may have parallel and spaced apart axes.

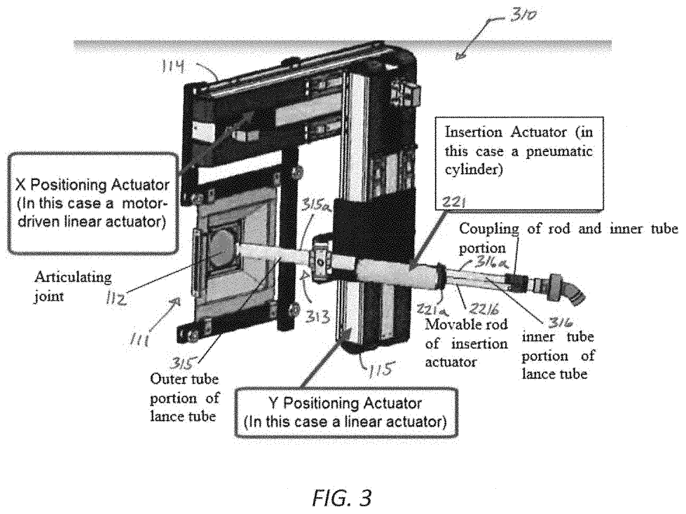

FIG. 3 illustrates an implementation of a cleaning system 310 for cleaning interior surfaces of the boiler 101. The cleaning system 310 is generally similar to the cleaning system 210 described above. As shown, the cleaning system 310 includes the wall port assembly 111 having the articulating joint 112, the X-positioning device 114, the Y-positioning device 115, and the insertion device 221. However, according to the illustrated implementation, the cleaning system 310 includes a lance tube 313 having an outer tube portion 315 and an inner tube portion 316 that are co-axial with one another. The inner tube portion 316 is axially slidable within the outer tube portion 315. The outer tube portion 315 is fixedly coupled to the articulating joint 112. The inner tube portion 316 includes an exterior inner tube portion 316a and an interior inner tube portion 316b. The exterior inner tube portion 316a is disposed external to the boiler wall 102, and the interior inner tube portion 316b is extendable into the interior 103 of the boiler 101 and includes the distal end of the lance tube 313 from which pressurized water or fluid flow during the cleaning cycle. FIG. 3 shows an exterior outer tube portion 315a of the outer tube portion 315 and the exterior inner tube portion 316a. In this implementation, the cleaning tip 220 is a hollow piece having openings at each end and is fixedly coupled around and to the distal end of the lance tube 313 (e.g., around the nozzle coupled to the lance tube 313). The openings allow the cleaning tip 220 to receive the distal end of the lance tube 313 and allow water to flow from the distal end of the lance tube 313 toward the interior wall(s) of the boiler 101. In one implementation, the cleaning tip 220 may be coupled to the distal end of the lance tube 313 by threadingly engaging the cleaning tip 220 with the distal end. However, in other implementations, the cleaning tip 220 may be coupled with the distal end of the lance tube 313 using one or more adhesives, an interference fit, one or more fasteners, and/or other suitable coupling mechanisms.

As shown, the X-positioning device 114 and the Y-positioning device 115 are motor-driven linear actuators. The Y-positioning linear actuator 115 is coupled to and between the X-positioning linear actuator 114 and the exterior outer tube portion 315a. The insertion device 221 is a pneumatic cylinder. The pneumatic cylinder 221 includes a housing 221a and a movable rod 221b that extends and retracts from the housing 221a. The housing 221a is coupled to the exterior outer tube portion 315a, and the movable rod 221b is coupled to the exterior inner tube portion 316a. Actuation of the pneumatic cylinder 221 causes the inner tube portion 316 to move axially relative to the outer tube portion 315. In the implementation shown, extension of the movable rod 221b from the housing 221a retracts the distal end of the interior inner tube portion 316b toward the wall port assembly 111, and retraction of the movable rod 221b into the housing 221a extends the distal end of the interior inner tube portion 316b away from the wall port assembly 111. However, in other implementations, the orientation of the pneumatic cylinder 221 relative to the inner tube portion 316 may be changed. And, in other implementations, the pneumatic cylinder 221 may be coupled to another portion of the wall port assembly 111.

Furthermore, in other implementations, the cleaning tip 220 may or may not be attached to the distal end of the lance tube 313. For example, the cleaning tip 220 may be coupled to the lance tube 313 differently (along an outer surface thereof but not coaxially as shown in FIGS. 2A-2D). And, in other implementations, the cleaning tip 220 may be coupled to a separate device that moves the cleaning tip 220 into the desired X/Y position ahead of extending it to push away deposits over the port opening 104.

In some implementations, the positioning devices and the insertion devices are controlled by a control system. For example, in some implementations, the control system includes a processor in communication with a memory, and the processor executes computer-readable instructions stored on the memory. The instructions cause the processor to generate and communicate a positioning signal to the one or more positioning devices that cause the positioning devices to move the lance tube and/or the cleaning tip as described above. And, the instructions cause the processor to generate and communicate an insertion signal to the one or more insertion devices that cause the insertion actuators to move the lance tube and/or cleaning tip between the retracted and extended positions. The control system may also provide power to the actuators.

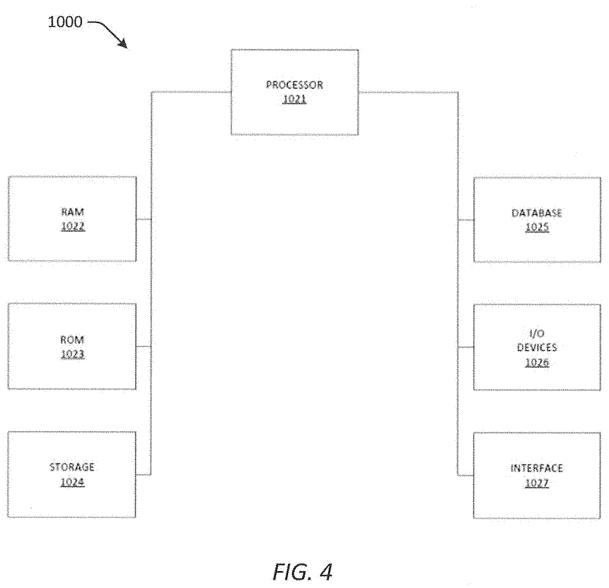

FIG. 4 illustrates an exemplary computer 1000 that may comprise all or a portion of a control system; conversely, any portion or portions of the computer illustrated in FIG. 4 may comprise all or a portion of a control system. As used herein, “computer” may include a plurality of computers. The computer(s) 1000 may include one or more hardware components such as, for example, a processor 1021, a random-access memory (RAM) module 1022, a read-only memory (ROM) module 1023, a storage 1024, a database 1025, one or more input/output (I/O) devices 1026, and an interface 1027. Alternatively, and/or additionally, the computer 1000 may include one or more software components such as, for example, a computer-readable medium including computer executable instructions for performing a method associated with the exemplary embodiments such as, for example, an algorithm for generating and communicating a positioning signal to the one or more positioning actuators that cause the positioning actuators to move the lance tube. It is contemplated that one or more of the hardware components listed above may be implemented using software. For example, storage 1024 may include a software partition associated with one or more other hardware components. It is understood that the components listed above are exemplary only and not intended to be limiting.

Processor 1021 may include one or more processors, each configured to execute instructions and process data to perform one or more functions associated with a computer for controlling a system (e.g., an irrigation system) and/or receiving and/or processing and/or transmitting data associated with generating and communicating a positioning signal to the one or more positioning actuators that cause the positioning actuators to move the lance tube. Processor 1021 may be communicatively coupled to RAM 1022, ROM 1023, storage 1024, database 1025, I/O devices 1026, and interface 1027. Processor 1021 may be configured to execute sequences of computer program instructions to perform various processes. The computer program instructions may be loaded into RAM 1022 for execution by processor 1021

RAM 1022 and ROM 1023 may each include one or more devices for storing information associated with operation of processor 1021. For example, ROM 1023 may include a memory device configured to access and store information associated with the computer, including information for identifying, initializing, and monitoring the operation of one or more components and subsystems. RAM 1022 may include a memory device for storing data associated with one or more operations of processor 1021. For example, ROM 1023 may load instructions into RAM 1022 for execution by processor 1021.

Storage 1024 may include any type of mass storage device configured to store information that processor 1021 may need to perform processes consistent with the disclosed embodiments. For example, storage 1024 may include one or more magnetic and/or optical disk devices, such as hard drives, CD-ROMs, DVD-ROMs, or any other type of mass media device.

Database 1025 may include one or more software and/or hardware components that cooperate to store, organize, sort, filter, and/or arrange data used by the computer and/or processor 1021. For example, database 1025 may store data related to generating and communicating a positioning signal to the one or more positioning actuators that cause the positioning actuators to move the lance tube. The database may also contain data and instructions associated with computer-executable instructions for controlling a system for cleaning an interior of an industrial-scale boiler. It is contemplated that database 1025 may store additional and/or different information than that listed above.

I/O devices 1026 may include one or more components configured to communicate information with a user associated with computer. For example, I/O devices may include a console with an integrated keyboard and mouse to allow a user to maintain a database of digital images, results of the analysis of the digital images, metrics, and the like. I/O devices 1026 may also include a display including a graphical user interface (GUI) for outputting information on a monitor. I/O devices 1026 may also include peripheral devices such as, for example, a printer, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 1027 may include one or more components configured to transmit and receive data via a communication network, such as the Internet, a local area network, a workstation peer-to-peer network, a direct link network, a wireless network, or any other suitable communication platform. For example, interface 1027 may include one or more modulators, demodulators, multiplexers, demultiplexers, network communication devices, wireless devices, antennas, modems, radios, receivers, transmitters, transceivers, and any other type of device configured to enable data communication via a wired or wireless communication network.

The figures illustrate the architecture, functionality, and operation of possible implementations of systems, methods and computer program products according to various implementations of the present invention. In this regard, each block of a flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementation was chosen and described in order to best explain the principles of the invention and the practical application, and to enable others of ordinary skill in the art to understand the invention for various implementations with various modifications as are suited to the particular use contemplated.

Any combination of one or more computer readable medium(s) may be used to implement the systems and methods described hereinabove. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

While the methods and systems have been described in connection with preferred implementations and specific examples, it is not intended that the scope be limited to the particular implementations set forth, as the implementations herein are intended in all respects to be illustrative rather than restrictive.

What is claimed is:

1. A system for cleaning an interior of a boiler, the system comprising:
a lance tube operatively coupled to one or more positioning devices, the lance tube comprising a distal end from which pressurized water flows out of the lance tube into the interior of the boiler, and the one or more positioning devices being configured for moving the distal end of the lance tube in an X direction and/or a Y direction relative to a wall of the boiler to direct the flow of water from the distal end of the lance tube; and
a cleaning tip coupled to one or more insertion devices, the one or more insertion devices being configured for moving the cleaning tip between a retracted position and an extended position.

2. The system of claim 1, wherein the cleaning tip is coupled to the lance tube.

3. The system of claim 2, wherein the cleaning tip comprises a fixed portion that is coupled to the lance tube and a movable portion that slides axially relative to the fixed portion in a direction of a port opening defined by the wall of the boiler.

4. The system of claim 3, wherein the fixed portion and the movable portion are co-axial with the lance tube.

5. The system of claim 1, wherein the one or more positioning devices comprise one or more positioning actuators, and wherein the one or more insertion devices comprise one or more insertion actuators.

6. The system of claim 5, further comprising a control system, the control system comprising a processor in communication with a memory, wherein the processor executes computer-readable instructions stored at the memory, wherein the computer-readable instructions cause the processor to generate and communicate at least one positioning signal to the one or more positioning actuators to cause the one or more positioning actuators to move the lance tube in the X direction and/or the Y direction and to generate and communicate at least one insertion signal to the one or more insertion actuators to cause the one or more insertion actuators to move the cleaning tip between the retracted and the extended positions.

7. The system of claim 1, wherein the one or more positioning devices comprise an X-positioning device and a Y-positioning device.

8. The system of claim 1, wherein the one or more insertion devices comprise a pneumatic cylinder.

9. The system of claim 1, wherein the distal end of the lance tube comprises a nozzle, and wherein the nozzle is insertable into the interior of the boiler.

10. The system of claim 1, wherein the lance tube comprises an inner lance tube portion and an outer lance tube portion that are co-axial with one another, and wherein the inner lance tube portion is axially slidable relative to the exterior lance tube portion.

11. The system of claim 10, wherein the inner lance tube portion is coupled to the one or more insertion devices, and wherein the one or more insertion devices are configured for causing a distal end of the inner lance tube portion to extend into and retract from the interior of the boiler.

12. The system of claim 11, wherein the outer lance tube portion is fixedly coupled to an articulating joint that rotates about a central point but does not translate in the X direction or the Y direction.

13. The system of claim 12, wherein the one or more positioning devices comprise an X-positioning device and a Y-positioning device.

14. The system of claim 13, wherein the outer lance tube portion is coupled to the X-positioning device and the Y-positioning device.

15. The system of claim 14, wherein the one or more insertion devices comprise a pneumatic cylinder.
